(19) United States
(12) Patent Application Publication
(10) Pub. No.: US 2025/0049253 A1
(43) Pub. Date: Feb. 13, 2025

(54) CLEANING DEVICE FOR A BEVERAGE PREPARATION MACHINE AND METHOD FOR CLEANING A BEVERAGE PREPARATION MACHINE

(71) Applicant: EVERSYS S.A., Sierre (CH)

(72) Inventors: Thorsten SCHINDLER, Salgesch (CH); Jonathan BESSE, Chamoson (CH); Grégoire LOCHER, Daillon (CH); Sébastien ROBYR, Sierre (CH); David CONSTANTIN, Veyras (CH)

(73) Assignee: EVERSYS S.A., Sierre (CH)

(21) Appl. No.: 18/719,530

(22) PCT Filed: Nov. 10, 2022
(86) PCT No.: PCT/EP2022/081381

§ 371 Date: Jun. 13, 2024

(30) Foreign Application Priority Data
Dec. 16, 2021 (DE) 10 2021 133 520.5

(51) Int. Cl. A47J 31/60; A47J 31/46

(52) U.S. Cl. CPC A47J 31/60; A47J 31/461

(57) ABSTRACT

In a cleaning device for a beverage preparation machine, in particular for a coffee machine, which includes a first chamber for receiving a cleaning agent and a liquid line system with a water line connectable to a water connection for supplying water and a discharge line connected to the first chamber and connectable to the beverage preparation machine, a first piston is insertable into the first chamber. With this cleaning device, the cleaning agent can be completely and homogeneously dissolved in the first chamber and thereby converted into a homogeneous cleaning agent solution, which can be supplied to the beverage preparation machine via the discharge line for carrying out a cleaning process.

### FIELD OF THE INVENTION

The invention relates to a cleaning device for a beverage preparation machine and to a method for cleaning a beverage preparation machine.

### BACKGROUND

Cleaning devices integrated into beverage preparation machines, such as semi-automatic or fully automatic coffee machines, are known from the prior art for cleaning beverage preparation machines. The cleaning device is used in predefined cleaning cycles both during operation and after the beverage preparation machine has been switched off, in order, for example, to clean the coffee- and milk-carrying components of coffee and milk residues and of impurities, and in this way to keep the beverage preparation machine in perfect hygienic conditions at all times. The cleaning cycles can either be started manually by an operator or automatically by a control system of the beverage preparation machine.

Cleaning devices for the automatic cleaning of beverage preparation machines are known from the prior art, in which a cartridge with a cleaning agent inserted therein is used. Such a cleaning device is known, for example, from DE 10 2015 108 438 A1, in which a cartridge filled with a cleaning agent is connected to a liquid supply for hot beverage preparation in the beverage preparation machine in order to feed a liquid, in particular water, into the cartridge and dissolve the solid cleaning agent contained in the cartridge. It can be ensured that an operator of the beverage preparation machine does not come into contact with the aggressive cleaning agent, as this is stored in a sealed manner in the cartridge. However, the dissolution of the cleaning agent in the cartridge in the liquid supplied to the cartridge is often incomplete because the water passed through the cartridge cannot completely convert the solid cleaning agent into a liquid cleaning agent solution. This makes it difficult to accurately meter an amount of cleaning agent required to complete a cleaning cycle or a concentration of cleaning agent required for this purpose in a cleaning agent solution produced by dissolving the cleaning agent in the liquid. Furthermore, cleaning devices with cleaning agent cartridges have disadvantages from the point of view of waste avoidance, because the emptied cartridges, which regularly have a plastic housing, are intended for single use and must be disposed of.

Another device for cleaning a coffee machine having a water tank, a heating device, a brewing unit and a water line system with a feed pump for conveying water from the water tank through the water line system is known from DE 10 2011 054 601 A1, wherein the cleaning device comprises a chamber for a descaling and/or cleaning agent, which chamber is connectable or connected to the water line system so that water from the water tank can be conveyed through the chamber into the water line system of the coffee machine by means of the feed pump of the coffee machine. This cleaning device is intended to allow a complete dissolution and mixing of the descaling and/or cleaning agent, in that the agent located in the chamber is dissolved in an aqueous solution by introduction and by transport of water through the chamber, and the aqueous solution is conveyed from the chamber into the water line system of the coffee machine, in particular in order to clean the brewing unit and/or the heating device with the cleaning agent solution. Even with this device, however, it is difficult to precisely meter the amount of cleaning agent required for a cleaning process or the concentration of the cleaning agent in the cleaning agent solution.

For the precise metering of a specific quantity of a cleaning agent required for carrying out a cleaning process in a beverage preparation machine, cleaning devices with a metering device for the cleaning agent are known from the prior art, wherein a solid cleaning agent, for example in powder, granulate, solid or tablet form, is fed to the metering device. From EP 1 210 894 B1, for example, a beverage machine, in particular a coffee machine, with a feed device for solid cleaning agent, in particular in pressed-body form, is known, in which an automatically metering, self-contained metering device for the cleaning agent is provided. The dosing device comprises a storage container for the solid cleaning agent and a dosing unit with a movable dosing chamber through which a predetermined quantity of the cleaning agent can be conveyed from the storage container into an outlet.

A further cleaning system for an automatic beverage dispenser, in particular a coffee machine, is known from EP 2 584 946 B1, wherein the cleaning system includes a cleaning device for periodic cleaning of the components coming into contact with the beverages by means of a cleaning liquid. To produce the cleaning liquid, a solid cleaning agent, which may in particular be in ball or tablet form, is dissolved in the cleaning liquid in the cleaning device. The cleaning device comprises a controlled metering device with a metering barrier, which releases the cleaning balls or tablets, which are stored in a storage container, into a discharge chute with a metering opening. Two counter-rotating metering screws are arranged between the storage container and the discharge chute, through which the cleaning balls or tablets can be conveyed individually into the discharge chute.

Cleaning devices known from the prior art with a metering device for the metered supply of a solid cleaning agent enable, on the one hand, a simple and safe handling of the cleaning agent and, on the other hand, a precise metering of the quantity of cleaning agent required for a cleaning process and a precisely metered active substance concentration of the cleaning agent in a cleaning liquid produced by dissolving the solid cleaning agent.

Based on this, there is a need for a cleaning device for cleaning beverage preparation machines, which enables a complete dissolution of a cleaning agent, which is supplied for example in powder or tablet form by means of a metering device, in a cleaning agent solution, in particular an aqueous solution of the cleaning agent, in order to produce an optimum concentration of the cleaning agent in the cleaning agent solution with a homogeneous concentration distribution over the volume of a dose of the cleaning agent solution. In particular, a complete dissolution or a homogeneous mixing of the cleaning agent in the cleaning agent solution shall be achieved. Furthermore, the consumption of cleaning agent is to be minimized. The cleaning device is to be controllable fully automatically by a control device of the beverage preparation machines in order, for example, to be able to carry out pre-programmed cleaning cycles fully automatically with an exact metering of the amount of cleaning agent required for the cleaning cycle and an optimum concentration of the cleaning agent in a dose of a cleaning agent solution required for the cleaning cycle.

### SUMMARY OF THE INVENTION

These tasks are solved by the device for cleaning a beverage preparation machine and by the method for cleaning a beverage preparation machine as disclosed herein. Preferred embodiments of the cleaning device and the method are also disclosed herein.

The cleaning device according to the invention comprises a first chamber for receiving a cleaning agent, in particular a solid cleaning agent, and a liquid line system coupled to the first chamber and comprising a water line connectable to a water connection for supplying water and a discharge line connectable to the first chamber and connectable to the beverage preparation machine, wherein a first piston insertable into the first chamber is provided.

Through the water line, water can be fed into the first chamber to dissolve a predetermined amount of the cleaning agent therein in an aqueous cleaning agent solution. The first piston, which is insertable into the first chamber, thereby enables a good and homogeneous mixing of the cleaning agent in the aqueous cleaning agent solution and the piston also closes a cleaning agent access into the first chamber, through which the cleaning agent is supplied when the piston is inserted into the first chamber in an operating position. When the first piston is in its operating position in the first chamber, water can be introduced into the first chamber via the water line to dissolve the amount of cleaning agent in the cleaning agent solution that is in the chamber. For this purpose, the first piston is preferably movably arranged in the first chamber between an upper base position, in which the first piston is pulled out of the first chamber, and the lower operating position, in which the first piston is located in the first chamber. This enables, on the one hand, a complete dissolution and a homogeneous mixing of the cleaning agent in the cleaning agent solution and homogeneous concentration of the cleaning agent in a predetermined dose of the cleaning agent solution and, on the other hand, ensures that no further cleaning agent can enter the chamber during dissolution or mixing of the cleaning agent, because the cleaning agent access of the chamber is closed by the inserted piston.

In a preferred embodiment of the cleaning device, the first piston is part of a piston unit which comprises the first piston, a second piston and a connecting line arranged between the first piston and the second piston and connecting the two pistons. In this case, the second piston is preferably arranged movably in a second chamber, the second chamber being arranged upstream of the first chamber, as seen in the direction of flow of the water supplied via the water line, and being connected to the first chamber in a fluid-conducting manner via the connecting line. Via the connecting line, a movement of the second piston in the second chamber is transmitted to the first piston. The water line is thereby preferably connected to a water inlet connection of the second chamber. This arrangement enables automatic movement of the first piston and the second piston connected thereto via the connecting line in the first and second chambers, respectively, when water is introduced into the second chamber through the water line. The pressure of the introduced water moves the second piston in the second chamber from a base position to an operating position, in particular from top to bottom, and the first piston thereby also moves to its operating position, while the water can flow through the connecting line from the second chamber into the first chamber to fill the first chamber with water and dissolve the amount of cleaning agent present therein.

To preload the piston unit, it preferably comprises a spring element which preloads the second piston in the second chamber in its base position. When water is introduced into the second chamber, the spring element is compressed by the water pressure against its restoring force, bringing the second piston and the first piston into their respective operating positions. The spring element is expediently arranged between the first piston and the second piston and in particular around the tubular connecting line, and the spring element is preferably supported on a support in the second chamber. The support is preferably arranged in an end region of the second chamber, in particular at a bottom of the second chamber, wherein the spring element extends between the support and an end face, in particular the lower end face, of the second piston. By means of this arrangement, the spring element exerts a bias on the first and the second piston in an unloaded state, which bias holds the first and the second piston in their respective base positions, wherein the first piston is pulled out of the first chamber in its base position and the second piston is located in its base position within the second chamber in an (upper) limit position, in which the second piston bears against an (upper) stop of the second chamber.

In order to ensure a safe movement of the first piston into its operating position when water is introduced through the water line and in order to hold the first piston in this operating position during the introduction of water, the second chamber preferably has a larger cross-section and, in particular, a larger diameter than the first chamber and, correspondingly, the second piston also preferably has a larger cross-section and, in particular, a larger diameter than the first piston. Due to the larger cross-section of the first piston compared to the cross-section of the second piston, the counterforce exerted by the water introduced into the first chamber on the first piston, in particular on its lower end face, is smaller than the force exerted by the water pressure on the second piston, in particular on its upper end face, as a result of which the first and second pistons are each held in their operating position as long as water is introduced via the water line.

Preferably, at least one valve, in particular a shut-off valve and/or a control valve, in particular a pressure control valve, and/or a pressure reducer is arranged in the water line. The arrangement of a shut-off valve makes it possible to open and close the water line and thereby to introduce water into the cleaning device and to stop the water supply. The arrangement of a pressure regulating valve and/or a pressure reducer in the water line makes it possible to set a predetermined water pressure, which is preferably in the range from 3 to 10 bar.

To seal the first and second chambers, the first piston and the second piston preferably each have at least one sealing element, the sealing element of the first piston bearing sealingly against an inner wall of the first chamber and the sealing element of the second piston bearing sealingly against an inner wall of the second chamber.

For the supply of a predetermined amount of cleaning agent, the first chamber preferably has at least one cleaning agent access, the cleaning agent access being expediently arranged in an upper region or at an upper end of the first chamber. The or each cleaning agent access comprises an opening in a wall of the first chamber, through which the cleaning agent, which is present, for example, in the form of tablets or balls or also as granules, powder or liquid, can be introduced into the first chamber.

Preferably, in its operating position, the first piston is located in the first chamber to such an extent that access from the opening of the cleaning agent inlet into the first chamber is blocked. This ensures that no further cleaning agent can be introduced into the first chamber during the introduction of water into the first chamber, thereby ensuring exact metering of the amount of cleaning agent in the first chamber and exact concentration of the cleaning agent in the cleaning agent solution.

Expediently, the cleaning agent access is coupled to a cleaning agent dispenser or dosing device to dispense a predetermined amount of the cleaning agent through the cleaning agent access into the first chamber. The cleaning agent dispenser or dosing device is preferably a dispenser with which balls or tablets of the cleaning agent, which are stored in a storage container, can be fed individually to the cleaning agent access. Such a dosing device is known, for example, from EP 2 584 946 B1. This ensures exact metering of the amount of cleaning agent introduced into the first chamber via the cleaning agent access. It is possible, for example, to introduce a predefinable number of cleaning agent balls or tablets into the first chamber, so that the number of balls or tablets can be used to generate different concentrations of cleaning agent in a dose of the cleaning agent solution predefined by the available volume of the first chamber.

For discharging the cleaning agent solution produced in the first chamber into a discharge line connected to the line system of the beverage preparation machine, the cleaning device preferably comprises a compressed gas line which can be coupled to a compressed gas source.

Preferably, the second chamber is connected to the pressurized gas line for this purpose, with the pressurized gas line expediently opening into the second chamber in an upper section or at an upper side. Alternatively, the compressed gas line can also open into the water line. Via the compressed gas line, after the water supply has ended and preferably after complete dissolution of the cleaning agent in the cleaning agent solution, a compressed gas (compressed gas), for example compressed air, can be introduced into the cleaning device and in particular into the second chamber and via the connecting line into the first chamber, in order to force the cleaning agent solution produced in the first chamber into the discharge line connected to the first chamber.

A shut-off valve and/or a control valve is preferably arranged in the discharge line in order to be able to open and close the discharge line or set a specific flow cross-section in the discharge line. The volume flow of the discharged cleaning agent solution and/or the pressure in the first chamber can be adjusted via a control valve arranged in the discharge line.

Depending on the position of the shut-off or control valve in the discharge line, the cleaning device can be operated in a continuous mode or in a batch mode. In a continuous operation, the shut-off or control valve in the discharge line is at least partially open while water is continuously fed through the first chamber, whereby the cleaning agent in the first chamber is dissolved or mixed in a cleaning agent solution and the cleaning agent solution is discharged directly and continuously through the open discharge line to the beverage preparation machine. In this case, the use of a control valve in the discharge line is advantageous because the flow cross-section in the discharge line can be adjusted by the position of the control valve. By changing the flow cross-section in the discharge line, the volume flow of the cleaning agent solution and the concentration of the cleaning agent in the cleaning agent solution can be adjusted. A nozzle arranged in the connection line ensures that the piston unit, and in particular the first piston, is held in a predetermined operating position, regardless of the position of the control valve in the discharge line.

In a batch operation, the shut-off or control valve in the discharge line is closed while water is fed at a predetermined pressure into the first chamber via the water line. A pressure regulating valve and/or a pressure reducer is preferably arranged in the water line for setting a specific water pressure. Via the water pressure, the exact position of the first piston in the first chamber can be set in the batch operation of the cleaning device with the discharge line closed in the operating position. The position of the first piston in the operating position thereby determines the volume in the first chamber in which the cleaning agent solution is generated by dissolving or mixing the cleaning agent. Therefore, the position of the first piston in the operating position determines the volume of a dose of the cleaning agent solution provided by the cleaning device for performing a cleaning operation. After completion of the dissolution or mixing of the cleaning agent in the cleaning agent solution, the water supply is stopped by closing the shut-off or control valve in the discharge line, and the dose of the cleaning agent solution located in the first chamber is directed to the beverage preparation machine by introducing a compressed gas, for example compressed air, into the first chamber while the valve in the discharge line is open. The volume flow of the cleaning agent solution supplied to the beverage preparation machine can be adjusted by the position of a control valve arranged in the discharge line.

To control a cleaning process for cleaning the beverage preparation machine, the cleaning device is preferably coupled to a control device of the beverage preparation machine, which automatically initiates a cleaning process at predefined times and/or events, e.g. when the beverage preparation machine is switched on or off or after a predefined number of beverage purchases. Various cleaning processes can also be set or are programmed in the control device, with each cleaning process preferably being assigned a specific dosage and/or concentration of the cleaning agent solution. Preferably, the control device is programmable so that an operator can set specific cleaning processes and cleaning cycles individually according to his or her needs or depending on the beverages produced with the beverage preparation machine.

To control the cleaning device, the valves arranged in the water line and in the discharge line are coupled to the control device. As a result, the water line and the discharge line can be opened and closed or a specific water pressure in the water line and/or a specific volume flow of the cleaning agent solution can be set by the control device when it is fed to the beverage preparation machine. Furthermore, the control device is preferably also coupled to the compressed gas source and/or a valve in the compressed gas line to control the supply of the compressed gas. If the cleaning agent inlet is coupled to a dispenser or a dosing device, the dispenser or the dosing device is expediently also controlled by the control device.

A particularly fast and complete dissolution of a solid cleaning agent in the cleaning agent solution can be achieved if warm or hot water is supplied to the first chamber in which the solid cleaning agent dissolves. Therefore, the water line is preferably coupled to a water connection that provides hot water, which in particular has a temperature between 40° C. and 100° C. In this regard, the water connection is conveniently coupled to a boiler or a flow heater of the beverage preparation machine, which produces hot water for the beverage preparation. In a preferred embodiment, the second chamber is thereby connected to the boiler or the instantaneous water heater, which provides hot water having a temperature of at least 60° C., via the water line.

In the method according to the invention for cleaning a beverage preparation machine with a cleaning device, which is in particular a cleaning device according to the invention and which comprises at least one first chamber, a specific amount of a cleaning agent is metered into the first chamber and then water is fed into the first chamber via a water line which can be connected to a water connection, as a result of which the cleaning agent dissolves in a cleaning agent solution, and subsequently or during the water feed the cleaning agent solution is fed to the beverage preparation machine via a discharge line connected to the first chamber. It is provided that the water fed into the first chamber has a temperature of at least 40° C., preferably of more than 60° C., and in particular between 60° C. and 100° C. Furthermore, the water fed into the first chamber preferably has a pressure of at least 3 bar, preferably between 3 bar and 10 bar and in particular between 4 bar and 6 bar.

In the system, the first chamber is preferably fluidically coupled to a second chamber, wherein the water line carrying the warm water is connected to the second chamber to direct the warm water into the second chamber and into the first chamber. Thereby, the warm water is introduced into the first chamber after a dosage of a certain amount of the cleaning agent. Thereby, during the water supply, the first piston is inserted and held in its operating position in the first chamber. The hot water thereby flows into the first chamber through the connecting line connecting the first and second pistons after the first piston is inserted. The connecting line, which is in particular tubular, preferably extends through the first and second pistons to establish a fluidic connection between the first chamber and the second chamber.

In this case, when water is supplied through the water line, the pressure generated by the water introduced presses the first piston into the first chamber, the pressure generated by the water introduced is first acting on the second piston, in particular its upper end face, and is transmitted by the latter to the first piston. In this case, the cross-section of the second piston, on which the pressure of the water acts, is preferably larger than the cross-section of the first piston, on which a counterpressure acts that is generated by the water flowing into the first chamber via the connecting line.

After the cleaning agent solution has been generated by dissolving the cleaning agent in the warm water that has been supplied to the first chamber, the supply of water is first stopped and then the cleaning agent solution is forced from the first chamber into the discharge line by introducing a compressed gas, in particular compressed air, into the first chamber and is thereby supplied to the beverage preparation machine. In a continuous operation, the cleaning agent solution generated in the first chamber can also be fed into the discharge line already during the water supply.

As soon as the cleaning agent solution has been completely transferred to the discharge line, the introduction of the pressurized gas into the first chamber is stopped, causing the second piston to automatically move out of the first chamber to its base position due to the restoring force of the spring element.

When the first piston is in its base position outside the first chamber, the cleaning agent access through which the cleaning agent is introduced into the first chamber is unblocked, and the cleaning agent access is blocked when the first piston is in an operating position inside the first chamber. This prevents cleaning agent from still entering the first chamber while the cleaning agent solution is being generated.

The system is preferably automatically controlled by a control device, which in particular controls a valve in the water line and/or a water connection connected thereto, a dispenser or dosing device for dispensing the determined amount of cleaning agent, a compressed gas source for introducing a compressed gas into the first chamber, and a valve in the discharge line, in order to carry out the steps described above for preparing a cleaning agent solution and carrying out a cleaning process.

In this context, the control device is preferably set up or programmable in such a way that a cleaning process is automatically carried out by the system after predetermined events, which are in particular dependent on an operation of the beverage preparation device, and/or after or at predetermined times, in which case, in the cleaning process, in particular the components of the beverage preparation device which come into contact with liquids for producing a beverage and/or with a beverage produced in the beverage preparation device are cleaned with the cleaning agent solution.

Furthermore, it is an object of the invention to provide a beverage preparation machine, in particular a coffee machine and/or a machine for preparing a powdered beverage, in which hot milk and hot or cold milk foam can also be prepared, preferably via an integrated milk module, wherein the beverage preparation machine is equipped with a cleaning device according to the invention. Preferably, a cleaning device according to the invention is integrated in the beverage preparation machine or can be inserted as a replaceable cleaning module. In particular, the beverage preparation machine comprises a brewing device for brewing a hot beverage, e.g. from ground coffee powder, tea leaves or cocoa powder, and/or a milk module for heating and/or foaming milk, as well as a line system for supplying water to the brewing device and for discharging the brewed beverage and/or the heated or foamed milk to an outlet, wherein the cleaning device is expediently coupled to the brewing device and/or to the milk module via the line system of the beverage preparation machine in order to be able to clean the brewing device and/or the milk module as well as the lines of the line system, in which the beverages and beverage ingredients are transported, with the cleaning agent solution generated in the cleaning device during a cleaning process.

### BRIEF DESCRIPTION OF THE DRAWINGS

These and other advantages as well as features of the invention result from the embodiment example described below with reference to the drawings. These show:

FIG. 1: A schematic representation of a first embodiment of a cleaning device according to the invention in a base position;

FIGS. 2A-2D: Schematic representations of the cleaning device of FIG. 1 in various positions during the initiation and execution of a cleaning cycle, wherein FIG. 2A shows the cleaning device in the base position, in which a solid cleaning agent is supplied, FIG. 2B shows the cleaning device in an operating position, in which water is supplied and the cleaning agent is dissolved therein to form a cleaning agent solution, FIG. 2C shows the cleaning device in the operating position in which the cleaning agent solution is discharged, and FIG. 2D shows the cleaning device again in the base position in which it is ready to receive the solid cleaning agent;

FIG. 3: A schematic representation of a second embodiment of a cleaning device according to the invention in a base position.

### DETAILED DESCRIPTION

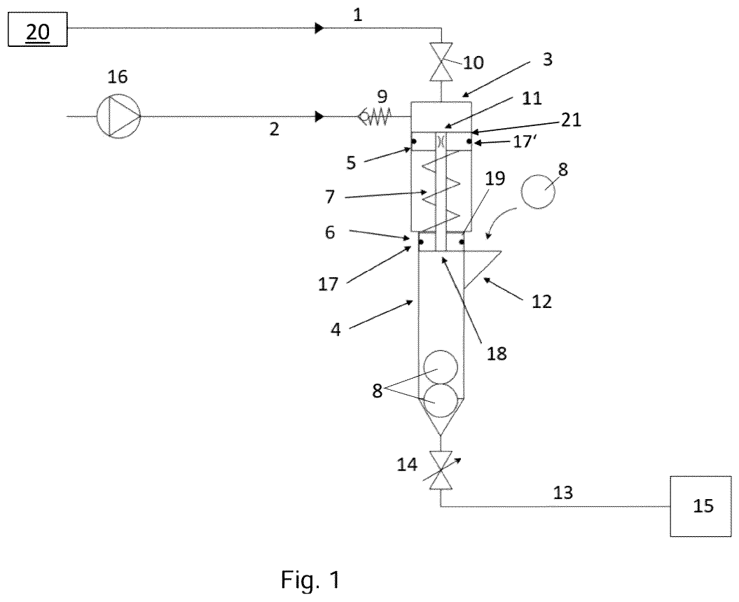

The cleaning device shown in FIG. 1 comprises a first chamber 4 with a first piston 6 movably arranged therein and a second chamber 3 with a second piston 5 movably arranged therein. The first chamber 4 and the second chamber 3 are of hollow cylindrical design and each have a cylindrical wall. The first chamber 4 extends in a vertical direction from an open upper end to a lower end, which is funnel-shaped and opens into a discharge line 13 connected to the first chamber 4. The first piston 6 can be inserted into the first chamber 4 through the open top end. The second chamber 3 is arranged above the first chamber 4 and also extends between an upper end and a lower end, the lower end having a bottom with a central opening. At the upper end of the second chamber 3, a water inlet port is arranged to which a water line 1 is connected. The water line 1 is part of a fluid line system of the cleaning device, which comprises the water line 1 and the discharge line 13. The water line 1 is connected to a water connection 20, which in particular provides heated water, preferably with a temperature of at least 40° C. and in particular in the range between 60° C. and 100° C. A shut-off valve 10 is arranged in the water line 1, which serves to open and close the water line 1. Instead of or in addition to a shut-off valve, a control valve and/or a pressure reducer can also be arranged in the water line 1.

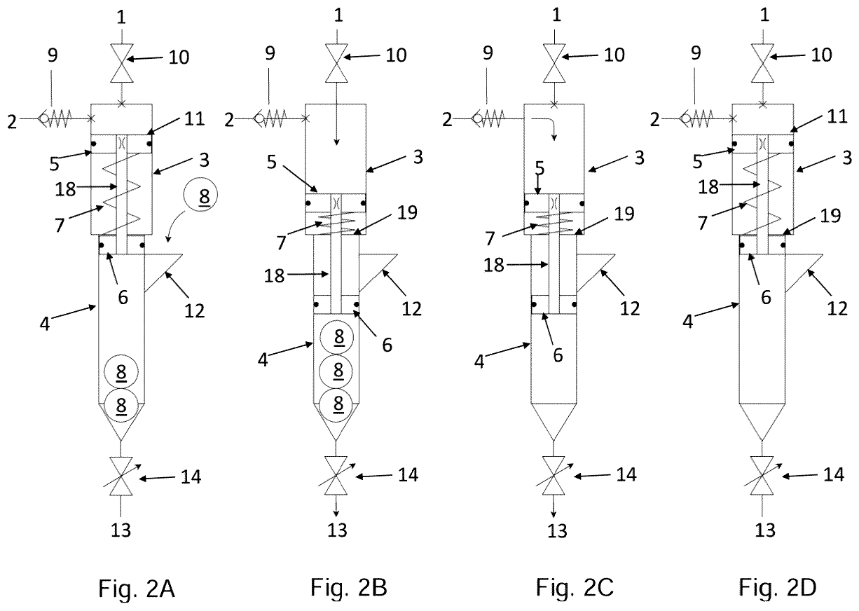

A stop 21 is arranged in the region of the upper end of the second chamber 3, which can be formed, for example, by an annular flange projecting from the wall of the second chamber 3 into the chamber interior. The second piston 5 is movably arranged in the second chamber 3 and can move in the second chamber 3 between a base position a and an operating position b, wherein an upper side of the second piston 5 in the base position a shown in FIG. 1 rests against the stop 21 and a lower side of the second piston 5 in the operating position b shown in FIG. 2B rests on the bottom of the second chamber 3 or is at least located near the bottom.

As can be seen from FIG. 1, the second chamber 3 has a larger cross-section and in particular a larger diameter than the first chamber 4. Accordingly, the second piston 5 also has a larger cross-section and, in particular, a larger diameter than the first piston 6.

The first piston 6 and the second piston 5 are each cylindrical or disc-shaped and are connected to each other via a connecting line 18, the connecting line 18 extending through both the first piston 6 and the second piston 5 and passing through the central opening in the bottom of the second chamber 3. The connecting line 18 thereby provides fluid communication between the first chamber 4 and the second chamber 3. A nozzle 11 is preferably arranged in the connecting line 18.

A spring element 7, for example a spiral spring, which extends between the underside of the second piston 5 and the bottom of the second chamber 3 is arranged in the second chamber 3. The spring element 7 is arranged in particular around the connecting line 18, as can be seen in FIG. 1. The bottom of the second chamber forms a support 19 on which the spring element 7 is supported. The second piston 5 in the second chamber 3 is preloaded in its (upper) base position a by the spring element 7. Accordingly, the first piston 6, which is connected to the second piston 5 via the connecting line 18, is also in an (upper) base position a, in which the first piston 6 is pulled out of the first chamber 4.

The first piston 6 and the second piston 5 each have at least one circumferential sealing ring 17, 17′ on their outer circumference, the sealing ring 17 of the first piston 6 bearing against the inside of the wall of the first chamber 4 and the sealing ring 17′ of the second piston 5 bearing against the inside of the wall of the second chamber 3, when the second piston 5 is moved in the second chamber 3 from its (upper) base position a into its (lower) operating position b and the first piston 6 simultaneously moves into the first chamber 4.

The first piston 6 and the second piston 5 as well as the connecting line 18 and the spring element 7 form a piston unit which is preloaded in a base position a by the spring element 7 and can be moved from the base position a to an operating position b by applying an external force.

A cleaning agent access 12 is arranged in the region of the upper end of the first chamber 4. The cleaning agent access 12 comprises a lateral opening in the wall of the first chamber 4, not shown here, through which a solid cleaning agent 8, for example in tablet or ball form, can be introduced into the first chamber 4. In order to dose the solid cleaning agent 8 in a predetermined amount into the first chamber 4, the cleaning agent access 12 is connected to a cleaning agent dispenser or a dosing device which doses the solid cleaning agent 8 through the cleaning agent access 12 into the first chamber 4. Preferably, the solid cleaning agent 8 is in the form of tablets or balls, which are individually dosed into the first chamber 4 by means of the cleaning agent dispenser or the dosing device. Several tablets or balls of the solid cleaning agent 8 can also be introduced into the first chamber 4 via the cleaning agent access 12, as indicated in FIG. 1 by the two cleaning agent balls 8, which are located at the lower, funnel-shaped end of the first chamber 4.

In the region of the upper end, a compressed gas line 2 opens into the second chamber 3. The compressed gas line 2 contains a check valve 9 and is connected upstream of the check valve 9 to a compressed gas source 16 which provides a compressed gas, for example compressed air. Instead of compressed air, other food-grade gases can also be provided under pressure by the compressed gas source 16. For this purpose, compressed nitrogen gas or compressed carbon dioxide, for example, may also be used instead of compressed air. The compressed gas source 16 can be formed, for example, by a compressor that draws in ambient air and compresses it to a predetermined pressure.

The discharge line 13 connected to the lower end of the second chamber 4 is coupled to a beverage preparation machine 15 and, in particular, is connected to a fluid line system of the beverage preparation machine 15 in order to direct an aqueous cleaning agent solution generated in the cleaning device into the fluid line system of the beverage preparation machine 15 and, in particular, into the components of the beverage preparation machine 15 that come into contact with the beverages prepared therein and/or the beverage ingredients used therefor. At least one valve is arranged in the discharge line 13 for opening and closing the discharge line 13. Preferably, the discharge line 13 contains a control valve 14, which has an adjustable flow cross-section.

The cleaning device shown in FIG. 1 is expediently arranged in a housing of the beverage preparation machine 15. Preferably, the cleaning device is inserted as an exchangeable module in the housing of the beverage preparation machine 15. The water connection 20 and the compressed gas source 16 are thereby preferably components of the beverage preparation machine 15, which on the one hand can be used in the production of beverages in the beverage preparation machine for the provision of hot water and compressed gas and on the other hand supply the cleaning device with hot water via the water line 1 and with a compressed gas via the compressed gas line 2. In this regard, the water connection 20 can be formed in particular by a boiler or a flow-through water heater of the beverage preparation machine 15.

A control device is provided for controlling the cleaning device, which controls in particular the valves 10 and 14 in the water line 1 and the discharge line 13, as well as the supply of a compressed gas from the compressed gas source 16 through the compressed gas line 2 and the introduction of a solid cleaning agent 8 through the cleaning agent access 12 into the first chamber 4. The control device can thereby expediently be part of the control device of the beverage preparation machine 15, which is set up in such a way that a cleaning process is initiated by the cleaning device after or at certain times or events, which in particular depend on the production of beverages in the beverage preparation machine 15.

In FIGS. 2A-2D, individual phases of a cleaning process, that can be carried out with the cleaning device of FIG. 1, are shown by different positions of the cleaning device, wherein the phases shown in FIGS. 2A-2D are carried out successively in the cleaning process in order to feed a cleaning agent solution generated in the cleaning device to a beverage preparation machine in a continuous operation or in a batch operation.

FIG. 2A shows the cleaning device in its base position a, which corresponds to the representation in FIG. 1. To initiate a cleaning process, with the compressed gas source 16 shut off or the compressed gas line 2 closed and the valves 10 and 14 closed, a predetermined amount of cleaning agent 8, for example a certain number of cleaning agent tablets or balls, is initially fed into the first chamber 4 through the cleaning agent access 12. Then, as shown in FIG. 2B, the valve 10 in the water line 1 is opened. Furthermore, the control valve 14 in the discharge line 13 is at least partially opened and, in particular, set to a predetermined flow cross-section. As a result, preferably warm water, for example with a temperature of 40° C. to 80° C., and with a predetermined pressure, which is preferably more than 3 bar and in particular between 4 bar and 10 bar and depends specifically on the water pressure provided by the public water supply, flows from the water line 1 into the upper area of the second chamber 3. The water pressure can thereby be set to a specific value by a pressure regulating valve or a pressure reducer in the water line 1, if necessary. As a result of the pressure of the inflowing water acting on the upper end face of the second piston 5, the second piston 5 in the second chamber 3 is moved from its base position a shown in FIG. 2A into the operating position b shown in FIG. 2B, in which the second piston 5 in the second chamber 3 is located near the bottom. Since the second piston 5 is coupled to the first piston 6 via the connecting line 18, the first piston 6 thereby also moves from its base position a shown in FIG. 2A, in which the first piston 6 is pulled out of the first chamber 4, to the operating position b shown in FIG. 2B, in which the first piston 6 is located within the first chamber 4 at a certain height. The first piston 6 is thereby arranged above the balls of the cleaning agent 8 located in the first chamber 4, as shown in FIG. 2B. By moving the first piston 6 into its operating position b shown in FIG. 2B, the cleaning agent access 12 and in particular the opening in the wall of the first chamber 4 is closed, so that no more cleaning agent can enter the first chamber 4 in an area below the first piston 6.

The water flowing into the second chamber 3 via the water line 1 flows through the nozzle 11 in the connecting line 18 into the first chamber 4, which is connected to the second chamber 3 via the connecting line 18 in a fluid-conducting manner. Due to the larger cross-section of the first piston 6 compared to the cross-section of the second piston 5, the counterforce exerted on the first piston 6 by the water introduced into the first chamber 4 is smaller than the force exerted on the second piston 5 by the water pressure, as a result of which the first piston 6 and the second piston 5 are each held in their operating position b as long as water is introduced via the water line 1. The nozzle 11 thereby ensures a sufficiently high pressure upstream of the nozzle 11 to keep the piston unit in its operating position b.

When water flows into the first chamber 4 in the area below the first piston 6, the balls of cleaning agent 8 in the first chamber 4 are dissolved to form an aqueous cleaning agent solution. The concentration of the cleaning agent 8 in the cleaning agent solution is determined by the amount of cleaning agent in the first chamber 4 and the volume flow of the water flowing through, which is determined by the set flow cross-section in the discharge line 13.

The closed cleaning agent access 12 ensures that no further cleaning agent can be added to the cleaning agent solution in the first chamber 4 while the cleaning agent 8 is being dissolved.

Thus, for a given flow cross-section in the discharge line 13 and a certain amount of cleaning agent 8 in the first chamber 4, a certain cleaning agent concentration is established in the cleaning agent solution, which flows continuously into the discharge line 13 and is thereby conveyed to the beverage preparation machine 15, in particular into the fluid line system of the beverage preparation machine 15. There, in particular the components of the beverage preparation machine 15 that come into contact with the beverage and/or the beverage ingredients (such as, for example, coffee powder, milk or milk foam) during the production of beverages are cleaned by the aqueous cleaning agent solution.

The temperature and pressure of the water introduced into the first chamber 4 ensures a complete dissolution of the solid cleaning agent 8 in the cleaning agent solution. After transfer of a sufficient quantity of the aqueous cleaning agent solution for the cleaning process, the valve 10 of the water line 1 is closed, thereby stopping the water supply. Then—as shown in FIG. 2C—a compressed gas, in particular compressed air, is introduced via the compressed gas line 2 into the upper region of the second chamber 3, the pressure of the compressed gas preferably being more than 1 bar and in particular between 1.5 bar and 3 bar. The pressure of the introduced compressed gas, which flows from the second chamber 3 via the connecting line 18 into the first chamber 4, forces a residual amount of the cleaning agent solution still in the first chamber 4 into the discharge line 13.

Instead of the continuous operation described above, the cleaning device can also be operated in a batch mode, in which a certain dose of a cleaning agent solution with a certain concentration of the cleaning agent is initially generated in the first chamber and then supplied to the beverage preparation machine 15 through the discharge line 13. In this batch operation, the volume of a dose of the generated cleaning agent solution is determined by the position of the first piston 6 in the first chamber 4 in its operating position b, since this position determines the volume of the first chamber 4 below the first piston 6 in which the solid cleaning agent 8 is located. In this regard, the position of the first piston 6 in the first chamber 4 in its operating position can be adjusted by the pressure of the water introduced via the water line 1 when the discharge line 13 is closed. Thus, the volume of the dose of aqueous cleaning agent solution in the first chamber 4 can be varied by the water pressure. Therefore, when the solid cleaning agent 8 is dissolved, a certain concentration of the cleaning agent 8 in the aqueous cleaning agent solution results, which is determined by the predetermined amount of the cleaning agent 8 in the first chamber 4 and the volume of the first chamber 4 below the first piston 6.

After the dissolution of the cleaning agent 8 in the cleaning agent solution, the generated dose of the cleaning agent solution is supplied to the beverage preparation machine 15 via the discharge line 13 by opening the discharge line 13, in particular the valve 14, with the valve 10 in the water line 1 closed, and a pressurized gas is introduced into the first chamber 4 by means of the pressurized gas line 2. The dose of aqueous cleaning agent solution has a certain concentration of cleaning agent in the cleaning agent solution, whereby the concentration can be varied by the amount of cleaning agent 8 supplied to the first chamber 4 and the water pressure during the preparation of the cleaning agent solution. A control valve 14 arranged in the discharge line 13 advantageously enables the setting of a certain volume flow of the aqueous cleaning agent solution from the first chamber 4 into the discharge line 13 when the cleaning agent solution is discharged.

After transfer of the cleaning agent solution from the first chamber 4 into the fluid line system of the beverage preparation machine 15 in the continuous operation or in the batch operation of the cleaning device, the cleaning process is completed and the cleaning device is returned to its base position a by stopping the supply of the compressed gas via the compressed gas line 2 with the valve 10 closed (by switching off the compressed gas source 16 or by closing the compressed gas line 2 with a valve). This causes the piston unit, which comprises the first piston 6, the second piston 5 and the connecting line 18, to move back to its base position a, which is shown in FIG. 2D. In this case, the piston unit is automatically brought into the base position a due to the restoring force of the spring element 7, in which the second piston 5 rests against the stop 21 of the second chamber 3 and the first piston 6 is pulled out of the first chamber 4 at least to such an extent that the first piston 6 is located above the cleaning agent access 12 and, in particular, above the opening in the wall of the first chamber 4, as shown in FIG. 2D. In this base position a of the cleaning device, the first chamber 4 is again available for receiving a predetermined amount of the solid cleaning agent 8, and in particular for receiving a predetermined number of balls or tablets of the cleaning agent 8, and the cleaning device can be used for a subsequent cleaning process.

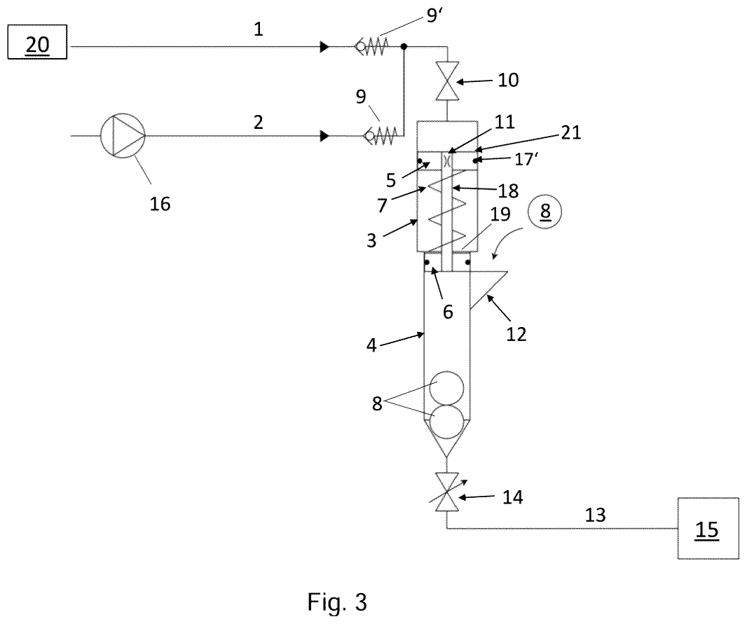

FIG. 3 shows a second embodiment of a cleaning device according to the invention in the base position. This embodiment corresponds to the cleaning device of FIG. 1, except for the arrangement of the compressed gas line 2, which in the embodiment of FIG. 3 does not open into the second chamber 3 but into the water line 1. In this case, a further check valve 9′ is arranged in the water line 1 to prevent compressed gas from flowing out of the compressed gas line 2 in the direction of the water connection 20. In this embodiment, the pressurized gas from the pressurized gas source 16 is directed into the water line 1 via the pressurized gas line 2 in order to force the cleaning agent solution located in the first chamber 4 into the discharge line 13 when the valve 10 in the water line 1 is open, after the cleaning agent has been completely dissolved or mixed in the cleaning agent solution. The embodiment of FIG. 3 is distinguished from the embodiment of FIG. 1 by a simpler structure of the second chamber 3.

The cleaning device according to the invention enables a fast and complete dissolution of the solid cleaning agent in the aqueous cleaning agent solution, in particular due to the pressure and temperature of the water supplied via the water line 1. Furthermore, an exact dosage of a quantity of the solid cleaning agent 8 as well as the maintenance of a certain concentration of the cleaning agent in the aqueous cleaning agent solution is ensured, wherein the exact concentration of the cleaning agent can be controlled, in particular, by the water pressure of the water supplied through the water line 1. The cleaning device has a simple and compact design and does not require motor control for transferring the cleaning device from its basic position a to its operating position b, and back.

1-29. (canceled)

30. A cleaning device for a beverage preparation machine, the device comprising a first chamber for receiving a solid cleaning agent, a liquid line system with a water line connectable to a water connection for supplying water and a discharge line, which is connected to the first chamber and is connectable to the beverage preparation machine, a piston unit comprising a first piston, a second piston and a connecting line which is arranged between the first piston and the second piston and is connecting the first piston with the second piston, wherein the first piston is insertable into the first chamber and water can be introduced into the first chamber via the connecting line when the first piston is inserted in the first chamber.

31. The cleaning device according to claim 30, wherein the first piston is movable between a base position, in which the first piston is withdrawn from the first chamber, and an operating position, in which the first piston is located in the first chamber.

32. The cleaning device according to claim 30, wherein the second piston is movably arranged in a second chamber, the second chamber being arranged upstream of the first chamber and being in fluid-conducting communication with the first chamber via the connecting line.

33. The cleaning device according to claim 30, wherein a movement of the second piston is transmitted to the first piston via the connecting line.

34. The cleaning device according to claim 31, wherein the piston unit comprises a spring element, wherein the spring element is arranged between the first piston and the second piston and is exerting a pretension on the first piston keeping the first piston in the base position in which the first piston is pulled out of the first chamber.

35. The cleaning device according to claim 34, wherein, when water is supplied through the water line, the first piston is moved against the pretension produced by the spring element from the base position into the operating position in which the first piston is located in the first chamber.

36. The cleaning device according to claim 32, wherein the second chamber has a larger cross-section area than the first chamber and/or wherein the second piston has a larger cross-section area than the first piston.

37. The cleaning device according to claim 30, wherein the first chamber comprises a cleaning agent access, which is comprising an opening in a wall of the first chamber.

38. The cleaning device according to claim 31, wherein the first chamber comprises a cleaning agent access and, in the operating position, the first piston is located in the first chamber to such an extent that the cleaning agent access is blocked.

39. The cleaning device according to claim 37, wherein the cleaning agent access is connected to a cleaning agent dispenser or a dosing device, which doses the cleaning agent through the cleaning agent access into the first chamber.

40. The cleaning device according to claim 32, wherein the second chamber is connected to a pressurized gas line, wherein the pressurized gas line can be coupled to a pressurized gas source and opens into the second chamber or into the water line.

41. The cleaning device according to claim 30, wherein at least one of a shut-off valve, a control valve and a pressure reducer is arranged in the water line.

42. A beverage preparation machine comprising at least one of a brewing device for brewing a hot beverage, a device for heating milk and a device for foaming milk, wherein the beverage preparation machine is further comprising a cleaning device according to claim 30.

43. A method for cleaning a beverage preparation machine comprising a cleaning device according to claim 30, wherein a specific quantity of a solid cleaning agent is metered into the first chamber and subsequently water is fed into the first chamber via the water line and the connecting line, while the first piston is inserted in an operating position in the first chamber, whereby the cleaning agent is dissolved in the water supplied into the first chamber to provide a cleaning agent solution, which can be supplied to the beverage preparation machine via a discharge line connected to the first chamber.

44. The method according to claim 43, wherein after metering the cleaning agent into the first chamber, the first piston is introduced into the first chamber in an operating position.

45. The method according to claim 43, wherein the second piston is movably arranged in a second chamber, the first chamber is fluidly coupled to the second chamber via the connecting line and the water line is connected to the second chamber, and wherein the first piston is pressed into the first chamber by a pressure generated by the introduced water when water is supplied through the water line, wherein the pressure generated by the introduced water acts on the second piston and is transmitted onto the first piston.

46. The method according to claim 43, wherein, after the cleaning agent solution has been generated by dissolving the cleaning agent in the water that has been supplied to the first chamber, the supply of water is first stopped and then the cleaning agent solution is forced from the first chamber into the discharge line by introducing a pressurized gas into the first chamber.

47. The method according to claim 46, wherein the introduction of the pressurized gas into the first chamber is stopped, when the cleaning agent solution has been completely transferred into the discharge line, wherein the first piston automatically moves out of the first chamber into a base position due to a restoring force acting on the first piston after the introduction of the pressurized gas has ended.

48. The method according to claim 47, wherein at least one of a shut-off valve and a control valve for opening and closing the discharge line is arranged in the discharge line, wherein, when the discharge line is at least partially open, water is passed into the first chamber, whereby the cleaning agent is dissolved in the supplied water into a cleaning agent solution, which is discharged to the beverage preparation machine through the discharge line.

49. The method according to claim 43, wherein at least one of a shut-off valve and a control valve for opening and closing the discharge line is arranged in the discharge line, wherein, when the discharge line is closed, water is passed into the first chamber, as a result of which the cleaning agent is dissolved in the supplied water into a cleaning agent solution, which can be discharged to the beverage preparation machine after the discharge line is opened.
